(19) United States
(12) Patent Application Publication
(10) Pub. No.: US 2024/0081195 A1
(43) Pub. Date: Mar. 14, 2024

(54) PLANT INJECTION SYSTEMS AND USES THEREOF

(71) Applicant: Invaio Sciences International GmbH, Basel (CH)

(72) Inventors: Antony Mathai CHETTOOR, Apex, NC (US); Michael Christian OEHL, Reinach (CH); Urs WIDMER, Dornach (CH)

(73) Assignee: Invaio Sciences International GmbH, Basel (CH)

(21) Appl. No.: 18/272,778

(22) PCT Filed: Jan. 28, 2022
(86) PCT No.: PCT/US2022/014410

§ 371 Date: Jul. 17, 2023

Related U.S. Application Data
(60) Provisional application No. 63/143,643, filed on Jan. 29, 2021.

(51) Int. Cl. A01G 7/06

(52) U.S. Cl. CPC A01G 7/06

(57) ABSTRACT

Provided herein are chassis for use in injection systems configured to penetrate a plant and distribute a liquid formulation to the plant, and the method of using the chassis.

### CROSS-REFERENCE TO RELATED APPLICATION

This application claims priority to U.S. Provisional Patent Application No. 63/143,643 filed Jan. 29, 2021, which is incorporated herein by reference in its entirety.

### FIELD

The present disclosure relates generally to systems and methods for administering formulations to plants, including injection tools, systems incorporating such injection tools, and methods of using such injection tools and systems for injecting liquid formulations into plants.

### BACKGROUND

Plant injection has been used for administration of active ingredients to plants. Conventional plant injection approaches can involve drilling a borehole in a tree trunk and stoppering the borehole with a peg. A needle is inserted through the peg to discharge liquid into the borehole.

What is desired in the art is an injection system that allows the user to easily control the depth of penetration or insertion by the injection tool housed or incorporated in the injection system. What is also desired in the art is an injection system that can be conveniently used to inject liquid formulations to relatively smaller plants.

### BRIEF SUMMARY

In some aspects, provided herein are various chassis suitable for integrating components of a plant injection system, such as injection tools. Such chassis are designed for use with various plant types, including plants with thinner stems and/or less mature stems. In some variations, the plant injection systems incorporating the housing or chassis herein may be suitable for use in small-scale plant injections, for example, in nurseries. In some variations, the plant injection systems incorporating the housing or chassis herein prevent leaking and damages to plants, especially for plants with thinner and/or less mature stems.

In other aspects, provided herein are also plant injection systems incorporating such chassis for administering fluids, for example, liquid formulations including one or more active ingredients into the interior of a plant or a plant part. In some embodiments, the plant injection systems further include an injection tool. In some variations, the chassis houses the injection tool. In some variations, the chassis is connected to a fluid delivery system, which includes a source of the liquid formulation. In some variations, the plant injection systems are configured to deliver the liquid formulation from the fluid delivery system through the injection tool, into the plant (e.g. a stem or thin trunk of the plant).

In certain aspects, provided are various clamp-style chassis and pushpin-style chassis, configured to integrate the injection tool and componentry for fluidly connecting the injection tool to a fluid delivery system; and, to install the injection tool and maintain it in position once installed on the plant.

In one aspect, described herein is a clamp-style chassis comprising a large arm, a small arm, and a biasing element. In some embodiments, the large arm comprises a first gripping end, a first actuating end, and a first connecting portion between the first gripping end and the first actuating end. In some variations, the small arm comprises a second gripping end, a second actuating end, and a second connecting portion between the second gripping end and the second actuating end. In some variations, the biasing element couples the first actuating end and the second actuating end, and is configured to push the first gripping end and the second gripping end toward each other. In some embodiments, the first connecting portion is larger than the second connecting portion. In some variations, the first connecting portion is connected to the second connecting portion to form a hinge. In some variations, the first gripping end, the second gripping end, and the first connecting portion form a jaw profile.

In another aspect, described herein are methods of using the plant injection system. In some embodiments, the method comprises squeezing the first actuating end and the second actuating end toward each other. In some variations, the method comprises placing the plant part between the first gripping arm and the second gripping arm. In some variations, the method comprises inserting at least a part of the injection tool into the plant part by pushing the chassis toward the plant part in the same direction as the longitudinal axis of the chassis. In some variations, the method comprises releasing the first actuating end and the second actuating end. In some variations, the method comprises injecting the liquid formulation into the plant part.

In another aspect, described herein is a clamp-style chassis comprising a first arm, a second arm, a connecting portion, and a biasing element. In some embodiments, the first arm comprises a first gripping end and a first actuating end. In some variations, the second arm comprises a second gripping end and a second actuating end. In some variations, the connecting portion connects the first arm and the second arm between the gripping and actuating ends. In some variations, the biasing element couples the first actuating end and the second actuating end, and is configured to push the first gripping end and the second gripping end toward each other. In some embodiments, the first gripping end, the second gripping end, and the connecting portion form a jaw profile.

In another aspect, described herein are methods of using the plant injection system. In some embodiments, the method comprises squeezing the first actuating end and the second actuating end toward each other. In some variations, the method comprises placing the plant part between the first gripping arm and the second gripping arm. In some variations, the method comprises inserting at least a part of the injection tool into the plant part by pushing the chassis towards the plant part in the same direction as the longitudinal axis of the chassis. In some variations, the method comprises releasing the first actuating end and the second actuating end. In some variations, the method comprises injecting the liquid formulation into the plant part.

In yet another aspect, described herein is another clamp-style chassis comprising a first arm, a second arm, a clamp, and a biasing element. In some embodiments, the first arm comprises a first pivoting end and a first actuating end. In some variations, the second arm comprises a second pivoting end and a second actuating end. In some variations, the clamp comprises a first side, a second side, and a base that form a U-shape having an interior surface and an exterior surface. In some variations, the first and second pivoting ends are mounted on the exterior surface of the clamp on the base. In some variations, the biasing element is connected to the exterior surface of the clamp on the first side and the second side. In some variations, the biasing element is configured to push the first side and the second side toward each other.

In another aspect, described herein are methods of using the plant injection system. In some embodiments, the method comprises placing the plant part between the first side and the second side. In some variations, the method comprises inserting at least a part of the injection tool into the plant part by pushing the chassis towards the plant part in the same direction as the longitudinal axis of the chassis. In some variations, the method comprises inserting the fixing element into one hole on the first side and a corresponding hole on the second side to surround the plant part with the clamp. In some variations, the method comprises injecting the liquid formulation into the plant part.

In one aspect, described herein is a pushpin-style chassis comprising a base, a button, and one or more fixing elements. In some embodiments, the base has an inner surface and an outer surface. In some variations, the button is mounted on the outer surface of the base. In some variations, the button is configured to push the injection tool into a plant part. In some variations, the one or more fixing elements are configured to mount the base onto a plant part. In some embodiments, the inner surface is bent to approximate the curvature of the plant part.

In another aspect, described herein are methods of using the plant injection system. In some embodiments, the method comprises bringing the inner surface of the base in contact with the plant part. In some variations, the method comprises mounting the base on the plant part using the one or more fixing elements. In some variations, the method comprises inserting at least a part of the injection tool into the plant part by pushing the button. In some variations, the method comprises injecting the liquid formulation into the plant part.

In some aspect, provided herein are plant injection systems comprising any of the chassis described herein and an injection tool. In some embodiments, the system further comprises a fluid delivery system. In some embodiments, the fluid delivery system is operatively connected to the injection tool. In some embodiments, the injection tool is a multiport injection tool, and the system further comprises a fluid receiving system. In some embodiments, the fluid receiving system is in fluid communication with the multiport injection tool.

### DESCRIPTION OF THE FIGURES

The present application can be understood by reference to the following description taken in conjunction with the accompanying figures.

FIGS. 1, 2, 3A, 3B, 4A, and 4B depict several exemplary clamp-style chassis housing an injection tool.

FIGS. 5A-5C depict an exemplary pushpin-style chassis housing an injection tool.

FIGS. 6A-6C depict an exemplary injection tool that can be housed in the chassis described herein.

FIGS. 7A-7C depict an exemplary multiport injection tool that can be housed in the chassis described herein.

FIGS. 8A and 8B depict exemplary plant injection systems.

### DETAILED DESCRIPTION

The following description sets forth exemplary methods, parameters, systems, devices and the like. It should be recognized, however, that such description is not intended as a limitation on the scope of the present disclosure but is instead provided as a description of exemplary embodiments.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The terms “comprising,” “including,” “having,” “involving” (and similarly “comprises,” “includes,” “has,” “involves,” and other forms of the terms), and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c.

Where ever the terms “a” or “an” are used, “one or more” is understood, unless such interpretation is nonsensical in context.

In some aspects, provided herein are various chassis suitable for integrating components of a plant injection system, such as injection tools. Such chassis are designed for use with various plant types, including plants with thinner stems and/or less mature stems. In some variations, the plant injection systems incorporating the housing or chassis herein may be suitable for use in small-scale plant injections, for example, in nurseries. In some variations, the plant injection systems incorporating the housing or chassis herein prevent leaking and damages to plants, especially for plants with thinner and/or less mature stems.

In other aspects, provided herein are also plant injection systems incorporating such chassis for administering fluids, for example, liquid formulations including one or more active ingredients into the interior of a plant or a plant part. In some embodiments, the plant injection systems further include an injection tool. In some variations, the chassis houses the injection tool. In some variations, the chassis is connected to a fluid delivery system, which includes a source of the liquid formulation. In some variations, the plant injection systems are configured to deliver the liquid formulation from the fluid delivery system through the injection tool, into the plant (e.g. a stem or thin trunk of the plant).

### Chassis

In certain aspects, provided are various clamp-style chassis and pushpin-style chassis, configured to integrate the injection tool and componentry for fluidly connecting the injection tool to a fluid delivery system; and, to install the injection tool and maintain it in position once installed on the plant.

Clamp-Style Chassis

In one aspect, described herein is a clamp-style chassis comprising a large arm, a small arm, and a biasing element. In some embodiments, the large arm comprises a first gripping end, a first actuating end, and a first connecting portion between the first gripping end and the first actuating end. In some variations, the small arm comprises a second gripping end, a second actuating end, and a second connecting portion between the second gripping end and the second actuating end. In some variations, the biasing element couples the first actuating end and the second actuating end, and is configured to push the first gripping end and the second gripping end toward each other. In some embodiments, the first connecting portion is larger than the second connecting portion. In some variations, the first connecting portion is connected to the second connecting portion to form a hinge. In some variations, the first gripping end, the second gripping end, and the first connecting portion form a jaw profile.

In some variations, the injection tool is mounted on the first connecting portion and within the jaw profile. In some variations, the injection tool is configured to insert into a plant part in the same direction as the longitudinal axis of the chassis. In some variations, the injection tool is configured to distribute a liquid formulation to the plant part.

In some embodiments, when the chassis is in a relaxed mode, the first actuating end and the second actuating end are maximally separated from each other. In some variations, when the chassis is in a strained mode, the first actuating end and the second actuating end are closer to each other than in the relaxed mode, and the first gripping end and the second gripping end are further away from each other than in the relaxed mode.

In some embodiments, the plant injection system is configured to operate in a pre-insertion configuration and an installed configuration. In some variations, in the pre-insertion configuration, the plant part is placed between the first gripping arm and the second gripping arm, but the injection tool is not inserted into the plant part. In some variations, in the installed configuration, the plant part is placed between the first gripping arm and the second gripping arm, and the injection tool is at least partly inserted into the plant part.

In some embodiments, the large arm and the small arm comprises a rigid material. In some variations, the rigid material comprises metal. In some variations, the biasing element is a spring. In some variations, the biasing element comprises metal, rubber, or silicone.

In another aspect, described herein are methods of using the plant injection system. In some embodiments, the method comprises squeezing the first actuating end and the second actuating end toward each other. In some variations, the method comprises placing the plant part between the first gripping arm and the second gripping arm. In some variations, the method comprises inserting at least a part of the injection tool into the plant part by pushing the chassis toward the plant part in the same direction as the longitudinal axis of the chassis. In some variations, the method comprises releasing the first actuating end and the second actuating end. In some variations, the method comprises injecting the liquid formulation into the plant part.

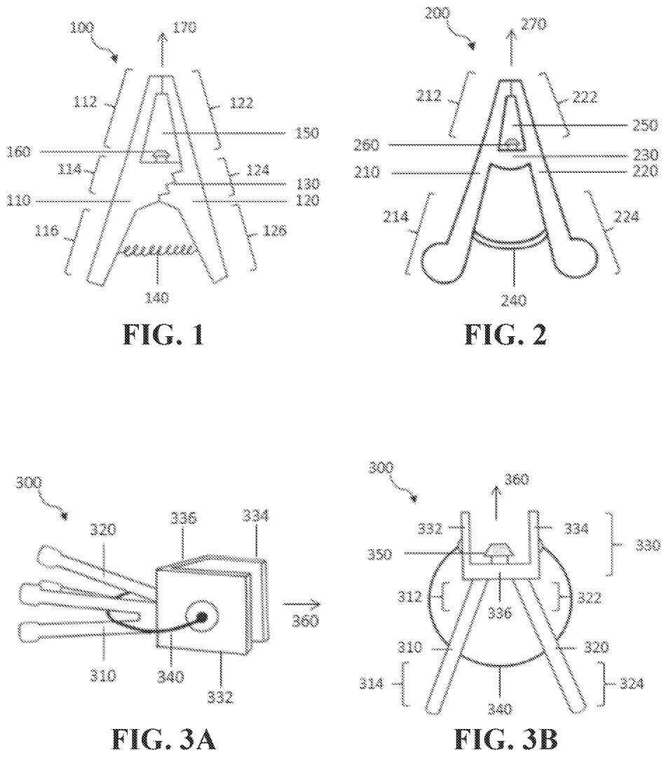

FIG. 1 depicts an example of a clamp-style chassis (chassis 100), which includes large arm 110 and small arm 120. Large arm 110 has gripping end 112, connecting portion 114, and actuating end 116, and small arm 120 has gripping end 122, connecting portion 124, and actuating end 126. Hinge 130 connects connecting portions 114 and 124, and biasing element 140 couples actuating ends 116 and 126. Gripping ends 112 and 122 and connecting portion 114 form jaw profile 150. Injection tool 160 is mounted on connecting portion 114 within jaw profile 150. Arrow 170 indicates the longitudinal axis of chassis 100.

In another aspect, described herein is a clamp-style chassis comprising a first arm, a second arm, a connecting portion, and a biasing element. In some embodiments, the first arm comprises a first gripping end and a first actuating end. In some variations, the second arm comprises a second gripping end and a second actuating end. In some variations, the connecting portion connects the first arm and the second arm between the gripping and actuating ends. In some variations, the biasing element couples the first actuating end and the second actuating end, and is configured to push the first gripping end and the second gripping end toward each other. In some embodiments, the first gripping end, the second gripping end, and the connecting portion form a jaw profile.

In some variations, the injection tool is mounted on the connecting portion and within the jaw profile. In some variations, the injection tool is configured to insert into a plant part in the same direction as the longitudinal axis of the chassis. In some variations, the injection tool is configured to distribute a liquid formulation to the plant part.

In some embodiments, when the chassis is in a relaxed mode, the first actuating end and the second actuating end are maximally separated from each other. In some variations, when the chassis is in a strained mode, the first actuating end and the second actuating end are closer to each other than in the relaxed mode, and the first gripping end and the second gripping end are further away from each other than in the relaxed mode.

In some embodiments, the plant injection system is configured to operate in a pre-insertion configuration and an installed configuration. In some variations, in the pre-insertion configuration, the plant part is placed between the first gripping arm and the second gripping arm, but the injection tool is not inserted into the plant part. In some variations, in the installed configuration, the plant part is placed between the first gripping arm and the second gripping arm, and the injection tool is at least partly inserted into the plant part.

In some embodiments, the first arm, the second arm, and the connecting portion comprises a rigid material. In some variations, the rigid material comprises metal. In some variations, the biasing element is a spring. In some variations, the biasing element comprises metal, rubber, or silicone.

In another aspect, described herein are methods of using the plant injection system. In some embodiments, the method comprises squeezing the first actuating end and the second actuating end toward each other. In some variations, the method comprises placing the plant part between the first gripping arm and the second gripping arm. In some variations, the method comprises inserting at least a part of the injection tool into the plant part by pushing the chassis towards the plant part in the same direction as the longitudinal axis of the chassis. In some variations, the method comprises releasing the first actuating end and the second actuating end. In some variations, the method comprises injecting the liquid formulation into the plant part.

FIG. 2 depicts an example of another clamp-style chassis (chassis 200), which includes arm 210 and arm 220. Arm 210 has gripping end 212 and actuating end 214, and arm 220 has gripping end 222 and actuating end 224. Connecting portion 230 connects arms 210 and 220, and biasing element 240 couples actuating ends 214 and 224. Gripping ends 212 and 222 and connecting portion 230 form jaw profile 250. Injection tool 260 is mounted on connecting portion 230 within jaw profile 150. Arrow 270 indicates the longitudinal axis of chassis 200.

In yet another aspect, described herein is another clamp-style chassis comprising a first arm, a second arm, a clamp, and a biasing element. In some embodiments, the first arm comprises a first pivoting end and a first actuating end. In some variations, the second arm comprises a second pivoting end and a second actuating end. In some variations, the clamp comprises a first side, a second side, and a base that form a U-shape having an interior surface and an exterior surface. In some variations, the first and second pivoting ends are mounted on the exterior surface of the clamp on the base. In some variations, the biasing element is connected to the exterior surface of the clamp on the first side and the second side. In some variations, the biasing element is configured to push the first side and the second side toward each other.

In some variations, the injection tool is mounted onto the interior surface of the clamp on the base. In some embodiments, the injection tool is configured to insert into a plant part in the same direction as the longitudinal axis of the chassis. In some variations, the injection tool is configured to distribute a liquid formulation to the plant part.

In some embodiments, when the chassis is in a relaxed mode, the first actuating end and the second actuating end are maximally separated from each other. In some variations, when the chassis is in a strained mode, the first actuating end and the second actuating end are closer to each other than in the relaxed mode, and the first pivoting end and the second pivoting end causes the clamp to expand.

In some embodiments, the plant injection system is configured to operate in a pre-insertion configuration and an installed configuration. In some variations, in the pre-insertion configuration, the plant part is placed between the first side and the second side, but the injection tool is not inserted into the plant part. In some variations, in the installed configuration, the plant part is placed between the first side and the second side, and the injection tool is at least partly inserted into the plant part.

In some embodiments, the biasing element comprises metal or rubber. In some variations, the first side, the second side, and the base comprises plastic or silicone.

In another aspect, described herein are methods of using the plant injection system. In some embodiments, the method comprises squeezing the first actuating end and the second actuating end toward each other. In some variations, the method comprises placing the plant part between the first side and the second side. In some variations, the method comprises inserting at least a part of the injection tool into the plant part by pushing the chassis toward the plant part in the same direction as the longitudinal axis of the chassis. In some variations, the method comprises releasing the first actuating end and the second actuating end. In some variations, the method comprises injecting the liquid formulation into the plant part.

FIGS. 3A and 3B depict an example of a clamp-style chassis (chassis 300), which includes arm 310 and arm 320. Arm 310 has pivoting end 312 and actuating end 314, and arm 320 has pivoting end 322 and actuating end 324. Side 332, side 334, and base 336 of clamp 330 form a U-shape, which has an interior surface and an exterior surface. Biasing element 340 connects exterior surface of side 332 and side 334. Pivoting end 312 and pivoting end 322 are mounted on the exterior surface of base 336. Injection tool 350 is mounted on the interior surface of base 336. Arrow 360 indicates the longitudinal axis of chassis 300.

In yet another aspect, described herein is another clamp-style chassis comprising a clamp and a fixing element. In some embodiments, the clamp comprises a first side, a second side, and a base that form a U-shape having an interior surface and an exterior surface. In some variations, the first side has one or more holes, and the second side has one or more corresponding holes. In some variations, the fixing element is configured to insert into one hole on the first side and a corresponding hole on the second side.

In some variations, the injection tool is mounted onto the interior surface of the clamp on the base. In some variations, the injection tool is configured to insert into a plant part in the same direction as the longitudinal axis of the chassis. In some variations, the injection tool is configured to distribute a liquid formulation to the plant part.

In another aspect, described herein are methods of using the plant injection system. In some embodiments, the method comprises placing the plant part between the first side and the second side. In some variations, the method comprises inserting at least a part of the injection tool into the plant part by pushing the chassis towards the plant part in the same direction as the longitudinal axis of the chassis. In some variations, the method comprises inserting the fixing element into one hole on the first side and a corresponding hole on the second side to surround the plant part with the clamp. In some variations, the method comprises injecting the liquid formulation into the plant part.

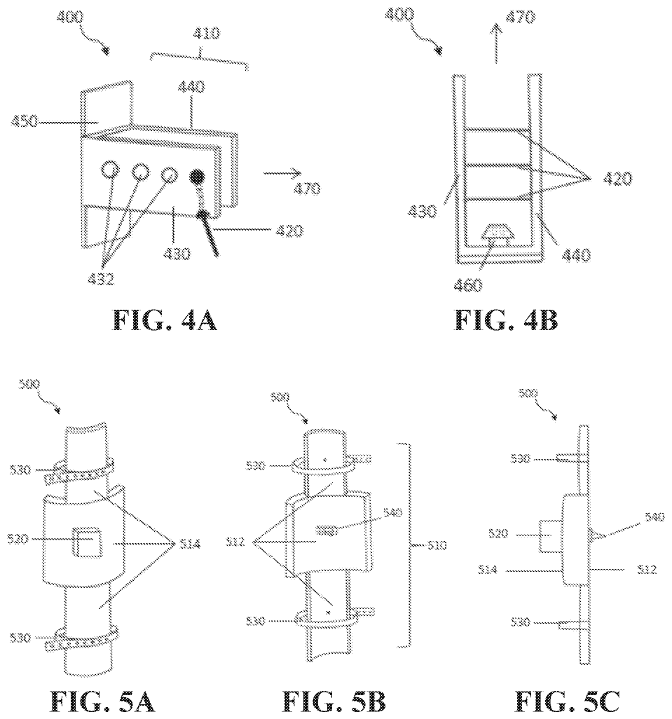

FIGS. 4A and 4B depict an example of a clamp-style chassis (chassis 400), which includes clamp 410 and fixing element 420. Clamp 410 has side 430, side 440, and base 450. Side 430 has holes 432, and side 440 has corresponding holes (not shown in the figure). Side 430, side 440, and base 450 of clamp 410 form a U-shape, which has an interior surface and an exterior surface. Injection tool 460 is mounted on the interior surface of base 450. Arrow 470 indicates the longitudinal axis of chassis 400.

Pushpin-Style Chassis

In one aspect, described herein is a pushpin-style chassis comprising a base, a button, and one or more fixing elements. In some embodiments, the base has an inner surface and an outer surface. In some variations, the button is mounted on the outer surface of the base. In some variations, the button is configured to push the injection tool into a plant part. In some variations, the one or more fixing elements are configured to mount the base onto a plant part. In some embodiments, the inner surface is bent to approximate the curvature of the plant part.

In some embodiments, an injection tool is mounted on the inner surface of the base, and configured to penetrate the plant part and distribute a liquid formulation to the plant part.

In another aspect, described herein are methods of using the plant injection system. In some embodiments, the method comprises bringing the inner surface of the base in contact with the plant part. In some variations, the method comprises mounting the base on the plant part using the one or more fixing elements. In some variations, the method comprises inserting at least a part of the injection tool into the plant part by pushing the button. In some variations, the method comprises injecting the liquid formulation into the plant part.

FIGS. 5A-5C depict an example of a pushpin-style chassis (chassis 500), which includes base 510, button 520, and fixing elements 530. Base 510 has inner surface 512 and outer surface 514. Injection tool 540 is mounted on inner surface 512 of base 510.

### Injection Tools

Any injection tools compatible with the clothespin-style and pushpin-style chassis described herein may be used. Suitable injection tools are described in, for example, WO 2020/021041 (see pages 32-38 and FIGS. 14-22) and WO 2021/152093 (see pages 52-64 and FIGS. 34-41 and 68-76), which are hereby incorporated herein by reference.

In some embodiments, the injection tools include a tool body, at least a portion of which is designed to be lodged into a plant, for example, the stem or trunk of a plant. The tool body has a channel system (having one or more channels) through which fluid can flow, terminating in an entry port through which fluid enters the injection tool and one or more distribution ports through which fluid is delivered to the interior of the plant. In some embodiments, the lodged portion of the tool is sized and shaped to minimize damage to the target plant when inserted into the plant, while maintaining efficient functionality of the injection tool in delivering the desired dosing of liquid formulation over the desired time period directly to the active vasculature of the plant.

In certain embodiments, the injection tools selected allow for precision delivery (also referred to as “precision injection”) of a formulation into the plant. Precision delivery refers to delivering the formulation only or substantially only into a target location in the plant. For example, in some embodiments, the target location is the active vasculature of the tree. In some variations, the active vasculature of a tree is the xylem and/or the phloem. In other embodiments, precisely delivering the liquid formulation comprises inserting the injection tool such that the distribution reservoir is positioned in and no further than the active vasculature of the plant.

In some embodiments, the size of the injection tool is small enough to be housed in the chassis described herein. In some embodiments, the length of the injection tool is less than any of the following: 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 60 mm, 70 mm, 80 mm, 90 mm, or 100 mm. In some embodiments, the length of the injection tool is less than 20 mm.

In some embodiments, the length of the injection tool is the length along the longitudinal axis of the injection tool. In some embodiments, the longitudinal length of the injection tool is the length along the penetrating direction of the injection tool.

In some embodiments, the length of the exposed or visible part of the injection tool when the injection tool is housed in the chassis (e.g., the visible portion of injection tools 160 in FIG. 1, 260 in FIG. 2, 350 in FIG. 3B, 460 in FIG. 4B, and 540 in FIG. 5C) is less than any of the following: 1.5 mm, 2 mm, 2.5 mm, 3 mm, 3.5 mm, 4 mm, 4.5 mm, 5 mm, 7.5 mm, 10 mm, 12.5 mm, 15 mm, 17.5 mm, 20 mm, 25 mm, 30 mm, 35 mm, 40 mm, 45 mm, or 50 mm. In some embodiments, the length of the exposed or visible part of the injection tool when the injection tool is housed in the chassis is less than 2.5 mm.

By having the penetrating structure or penetrating element, the injection tool can be inserted, such as screwed, driven or knocked, into the plant without previous formation of a receiving recess. Rather, the injection tool according to the disclosure more or less automatically generates the required hole while being advanced into the plant. It can therefore be inserted into the plant in a single work step. Thus, the injection tool allows for reducing the amount of work involved which can make the complete process considerably more efficient.

In another embodiment, the penetrating element includes a wedge body profile (e.g., tapering from a proximal portion to a distal portion, such as a spike, nail, wedge or the like). A wedge body profile allows for efficiently advancing the injection tool into the plant, for instance with a hammering or driving action. In this example, the injection tool includes a penetrating distribution body including one or more of a wedge or shaft profile have a tapered shape. For instance, the penetrating distribution body is conical and includes with external longitudinal furrows or flutes (e.g., examples of distribution reservoirs). The injection tool includes a strike head (optionally as a feature of the base). Optionally, a conical portion of the penetrating distribution body is closer to the base than the nail tip portion (or cutting element).

In still another embodiment, the injection tool has a wedge portion (wedge body profile) in a lance tip shape equipped with the penetrating element including a leading end or cutting edge at its front end or distal portion. In this convention the term “front end” can relate to a distal portion of the penetrating distribution body directed toward the plant and engaging with the plant at penetration. This example wedge body profile is an alternative wedge profile allowing efficient advancing of the injection tool into the plant. In particular, the wedge body profile opens the plant by spreading apart cut plant tissue. In some examples, the wedge body profiles accesses interior of the plant with minimal impairment (e.g., little or no damage) of the plant interior structure. For instance, spreading with a wedge body profile leaves the liquid transport structure of the plant, such as capillaries or the like, minimally impaired (including unimpaired or minimally impaired).

In one example, the wedge body profile includes a flat lance tip or leading edge having two or more lateral wing-like portions. Optionally, the wedge body profile, is chosen based on the plant for treatment. For instance, the robustness of the wedge body profile is adapted to the intended application or plant. Depending on the plant, the cutting element is selected with a nail tip type wedge (e.g., a circular or conical type wedge) or wedge body profile having two or more wings extending from a leading edge of the penetrating distribution body.

Optionally, in some variations, the penetrating distribution body including one or more of the profiles described herein includes one or more openings, such as distribution reservoirs. The distribution reservoirs provide one or more spaces, cavities, recesses, pockets or the like inside the plant when the injection tool is inserted. The distribution reservoirs facilitate the distribution of liquid formulations, for instance by retaining the formulations in the cavities of the reservoirs and at the same time engaging the formulations with the plant tissue. In other examples, the distribution reservoirs include distribution channels that facilitate delivery of the liquid formulations within the channels and along the body profile of the penetrating distribution body. The injection tools described herein include one or more inlet passages and associated distribution ports. Optionally, the injection tools include plural inlet passages that provide liquid formulations to a plurality of distribution ports. For example, the injection tools include at least one inlet passage or passages each ending in at least one distribution port. Optionally, the injection tools include one or more of the previously described distribution reservoirs (sometimes referred to as openings), and the distribution ports open into the distribution reservoirs.

The injection tools described herein include a channel (e.g., an inlet passage) and at least one distribution port connected to the channel. The inlet passages (or channels) provide a distributed network of outlets or distribution ports for the injection tool for efficient distribution of the liquid active ingredient formulation at one or more locations within the plant.

The at least one distribution port extends from the main channel. The at least one distribution port (also referred to as an outlet channel) facilitates the delivery of the liquid active ingredient formulation to one or more locations relative to the injection tool.

The distribution ports described herein (alternatively, outlet channels) are oriented transversely relative to the penetrating direction of the injection tools (e.g., corresponding to a longitudinal body axis of the tools). For instance, the transverse distribution ports are oriented at an angle relative to the penetrating direction. In one example, the distribution ports are oriented to open at 90 degrees relative to the penetrating movement direction. In another example, the distribution ports are oriented at angles between around 100 to 180 degrees relative to the penetrating movement direction (e.g., the longitudinal body axis of the injection tools). In some embodiments, the distribution ports are oriented at angles between around 90 to 180 degrees relative to the penetrating movement direction.

In connection with the orientation of the distribution ports one or more of the following three directions are considered, an insertion direction, a penetrating movement direction and an outlet (or distribution) direction. In an example, the insertion direction is the general direction the injection tool is inserted or advanced into the plant (e.g., from the exterior of the plant toward the interior). The insertion direction generally conforms with an axis of the injection tool, for instance the longitudinal body axis described herein. Accordingly, the longitudinal body axis is used as a reference location corresponding to the insertion direction when discussing the orientation of the distribution ports.

The penetrating movement direction is the direction the injection tool is to be moved (e.g., rotated) in order to penetrate the plant for insertion. In embodiments of injection tools having cutting elements in the manner of a drill bit portion or threading, the penetrating movement direction lies along the thread of the drill bit portion or the screw portion (and in some examples is indicated with a circle and dot in the figures indicating the penetrating movement direction into and out of the page). The distribution ports, for instance provided between threads, extend in a transverse orientation relative to the penetration movement direction in addition to the insertion direction. With the injection tool embodiments herein having wedge body profiles that are tapped or struck for penetration of the plant, such as injection tools with a nail tip portion or a wedge portion (e.g., example wedge profiles), the penetrating movement direction corresponds with the insertion direction. In each of the embodiments described herein (e.g., shaft or wedge profiles) the one or more distribution ports are transverse (include an outlet or opening direction at a different angle) to the longitudinal body axis and the corresponding insertion direction. Additionally, in the example embodiments including a shaft profile, for instance having threading or drill bit type cutting elements, the one or more distribution ports (e.g., the outlet direction or opening direction of the ports) are transverse (at a different angle) to the penetrating movement direction. Accordingly, each of the insertion direction and the penetrating movement direction are referred to collectively as penetrating directions, and the outlet or opening directions of the distribution ports of the injection tools are transverse to the respective penetrating directions of the embodiments.

In some examples, the opening direction or outlet direction of the one or more distribution ports extends backward relative to the penetrating direction including the penetrating movement direction described herein. The term “backwardly extending” or the like in this context relates to an extension of the at least one distribution port in a converse or opposed orientation relative to the penetrating movement direction. Backwardly extending is not limited to an extension opposite to the penetrating movement direction, i.e. a rearward direction in the narrow sense, but rather to an extension at an angle to the penetrating movement direction different from a right or larger angle. For example, in some examples the distribution ports are oriented 105 degrees relative to the penetrating movement direction.

In another example, by orienting the one or more distribution ports more than 90 degrees relative to the penetrating movement direction clogging of the distribution ports with plant tissue is minimized (e.g., eliminated or minimized). Accordingly, plugging is minimized and the liquid active ingredient formulations are effectively and efficiently provided through one or more distribution ports.

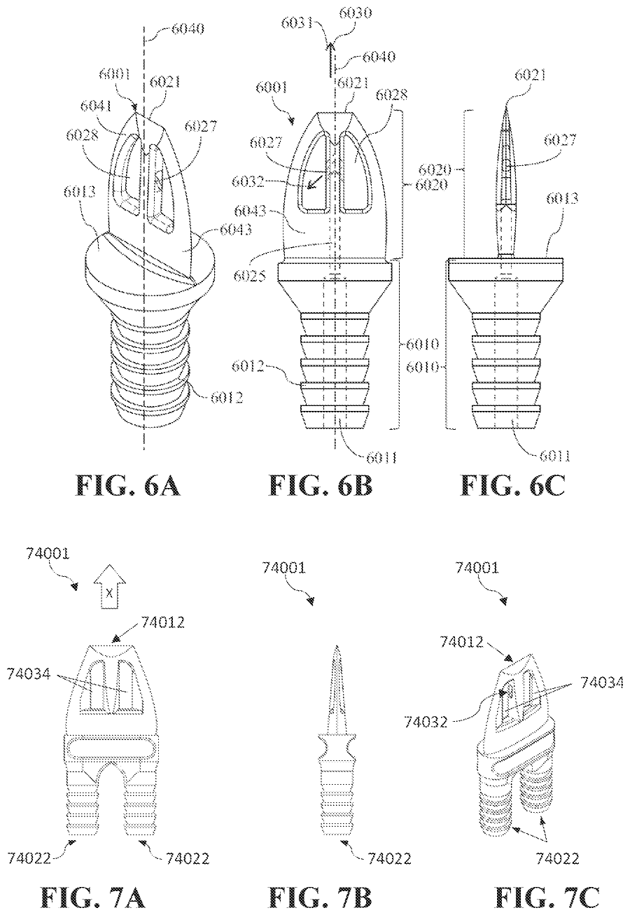

Injection tool 6001 shown in FIGS. 6A-6C is an exemplary injection tool compatible with the clothespin-style and pushpin-style chassis described herein. Injection tool 6001 is configured for use with less robust plants (e.g., softer trees, vines, stems or the like) typically having a softer shell. For instance, the previously described injection tools may have length of 50 mm or greater. In one example, these injection tools include penetrating distribution bodies (e.g., wedge or shaft body profiles) with a length of 35 mm or greater and a width of 30 mm or greater. In contrast, the example injection tools 6001 shown in FIGS. 6A-6C in some examples have total lengths of about 5 mm or between around 2.5 mm and 7.5 mm.

Injection tool 6001 has a wedge portion 6020, such as a penetrating distribution body having a wedge type body profile. Injection tool 6001 includes a strike head 6010 (an example of a base) and the wedge portion 6020 (an example of a penetrating distribution body). The wedge portion 6020 includes a cutting element. For example the wedge portion 6020 includes a cutting edge along the front face 6021 directed distally away from the strike head 6010. The wedge portion 6020 includes at least partially coextensive penetration and distribution elements. For example, the penetrating element extends from the cutting edge along the front face 6021 and proximate to a distal portion 6041 to a proximal portion 6043 of the wedge portion 6020. Similarly, the distribution element 6012 (including the outlet channels 6027 and distribution openings 6028) are within the penetrating element of the wedge portion 6020. As shown in the side view of FIG. 6C, the penetrating element of the wedge portion 6020 increases in thickness from the distal portion 6041 toward the proximal portion 6043 and the strike head 6010.

The strike head 6010 optionally includes a ribbed outer structure 6012, such as attachment cleats, to facilitate grasping of the strike head 6010 and to securely connect the injection tool 6001 with a delivery device. At the transition between the strike head 6010 and the wedge portion 6020 a step is provided. The step forms an abutting face 6013. The abutting face 6013 extends relative to (e.g., away from) the wedge portion 6020. During insertion of the injection tool 6001 the abutting face 6013 contacts the plant and arrests further advancement of the injection tool 6001 into the plant. In comparison to the abutting faces of other injection tools described herein the abutting face 6013 is relatively large in comparison to the associated wedge portion 6020 (e.g., they have a similar size). The larger abutting face 6013 facilitates use with smaller and less robust plants having a comparably soft shell or boundary. The relatively large abutting face distributes forces from insertion over the correspondingly large face 6013 and thereby minimizes trauma to the plant. The abutting face 60313 further provides an enclosing face for the injection tool 6001 for establishing a robust coupling with the plant.

As shown in FIGS. 6B and 6C, the strike head 6010 is includes an attachment opening 6011 (e.g., an example of an inlet port). The attachment opening 6011 is in communication with the outlet channels 6027 and the distribution openings 6028, for instance with a main channel 6025 (e.g., an inlet passage). As shown in FIGS. 6A and 6B, outlet channels 6027 (e.g., distribution ports) are in communication with the main channel 6025 and open transversely into the respective distribution openings 6028 (e.g., distribution reservoirs).

Fluid active ingredient formulation is delivered from the outlet channels 6027 transversely, for instance relative to the longitudinal body axis 6040 and the corresponding insertion direction 6030, into the distribution openings 6028. The distribution openings 6028 retain the formulation in residence proximate to adjacent plant tissues. In the example shown in FIG. 6B, the outlet channels 6027 extend proximally toward the strike head 6010 and transverse relative to the insertion direction 6030 of the injection tool 6001. The main channel 6025 and the outlet channels 6027 form a channel system of the injection tool 6001.

The operation of the injection 6001 is similar in at least some regard to other injection tools described herein. Because of the relatively small profile of the injection tool 6001 (or contracted forms of the other tools) the injection tool 6001 is readily inserted and installed in comparably small plants or less robust plants having a softer plant material (e.g., tissues or the like). For instance, the injection tool 6001 is configured for softened striking or manual pressing of the tool 6001 into the plant, for instance into a stem.

As shown in FIG. 6B, the injection tool 6001 is inserted along an insertion direction 6030 corresponding to the longitudinal body axis 6040 of the insertion tool 6001. While advancing the injection tool 6001 into the plant the tool moves along a penetrating movement direction 6031, and in the example shown the insertion direction 6030 corresponds with the penetrating movement direction 6031. In a similar manner to the other injection tools having a wedge type body profile and described herein the wedge portion 6020 of the injection tool 6001 spreads the plant material aside as the tool 6001 is inserted into the plant. Spreading of the planter material minimizes trauma to the plant material, and in some examples facilitates enhanced uptake of formulations.

As further shown in FIG. 6B, the outlet channels 6027 (e.g., distribution ports) extend in an outlet direction 6032 toward the distribution openings 6028 (e.g., distribution reservoirs). The outlet direction 6032 is transverse to the to the penetrating movement direction 6031 (and the longitudinal body axis 6040). For example, the outlet direction 6032 is misaligned with the penetrating movement direction 6031, the insertion direction 6030 (collectively penetration directions) and the longitudinal body axis 6040 with an angle of 125 degrees or the like. The transverse orientation of the outlet channels 6027 isolates the outlet channels 6027 from plant material otherwise introduced into the outlet channels with insertion. Further, the distribution openings 6028 (e.g., distribution reservoirs) facilitate positioning of the outlet channels 6027 within the body profile, for instance recessing the channels 6027 from an exterior of the body profile.

In other variations, multiport injection tools may be used with the chassis or the plant injection systems described herein. In some embodiments, the multiport injection tools comprise a tool body, at least a portion of which is designed to be lodged in the trunk of a plant. The tool body has a channel system (having one or more channels), through which fluid can flow, terminating in one or more distribution ports and two or more access ports; the channel system provides fluid communication between the distribution ports and access ports. While the specification primarily describes a specific multiport injection tool embodiment, a person of skill, based upon this disclosure can envision a variety of injection tools that may be modified as multiport injection tools consistent with this disclosure. For example, other injection tools described herein can be modified to include two access ports in fluid communication with a channel system providing fluid communication between the access ports and distribution ports. Accordingly, the specific multiport injection tool examples herein are non-limiting.

The present disclosure also provides plant injection systems for administering fluids, for example liquid formulations including one or more active ingredients (“AI fluid”), to a plant comprising the multiport injection tool. The plant injection systems comprise a fluid delivery system, a fluid receiving system, and a multiport injection tool wherein the fluid delivery system is operatively connected to a first port of the multiport injection tool and the fluid receiving system is in fluid communication with a second port of the multiport injection tool. The fluid delivery system facilitates flow of fluid (as previously described in connection with other embodiments above) from a source of fluid supply through a channel system in the multiport injection tip from a first access port to a second access port and to distribution port(s) and consequently to the interior of the plant. The fluid receiving system may have an open position in which fluid may flow through or be evacuated from the fluid receiving system and a closed position in which fluid is retained in the fluid receiving system.

In some embodiments, the injection tool may have one, two, three, or five distribution ports. In some variations, each distribution port is directly connected to an access port. In some variations, at least one distribution port is directly connected to an access port. In some variations, at least one distribution port is directly connected to more than one access port. In some variations, the connection between the access port and the distribution port is bent. In some variations, the connection between the access port(s) and the distribution port(s) is straight. In some variations, the connection between the access port(s) and the distribution port(s) occurs through an internal channel system (including a port manifold, a port junction, and a delivery channel, as described below). In some embodiments, the multiport injection tool includes one or multiple access ports that connect directly to one distribution port (e.g. without a port manifold, port junction, and delivery channel).

In other embodiments, the multiport injection tool may have one, two, three, four, five, or six distribution reservoirs. In some embodiments, distribution reservoirs receive active ingredient formulation from a distribution port connected to another distribution reservoir. In some embodiments, distribution reservoirs receive active ingredient formulation from a distribution port directly connected to an access port. In some embodiments, distribution reservoirs receive active ingredient formulation from a distribution port connected to an access port by an internal channel system.

FIGS. 7A-7C show exemplary multiport injection tool 74001. In this example, access ports 74022 are aligned with the penetrating direction “X.” Distribution ports 74032 are positioned in a shared wall of distribution reservoirs 74034, proximal to cutting element 74012.

### Fluid Delivery Systems

The clothespin-style and pushpin-style chassis housing the injection tool is operatively connected to a fluid delivery system that contains the liquid formulation. In some embodiments, the fluid delivery system and the source of the liquid formulation are integrated into a formulation cartridge, such as a pressurized container. In some variations, the formulation cartridge is a pressurized canister. In operation, the liquid formulation flows from the fluid delivery system through the injection tool into the plant. See, e.g., WO 2020/021041 (see pages 17, 19, and 21-25, and FIGS. 1 and 5-8) and WO 2021/152093 (see pages 3-6, 20, and 71-86, and FIGS. 34, 38-41, and 57), which are hereby incorporated herein by reference.

In some embodiments, the injection systems or components thereof used in the methods described herein are as depicted in the figures. In some embodiments, the systems are configured to administer liquid formulation comprising one or more active ingredients (including, for example, nutrients) to a plant or a part thereof. In some embodiments, such systems are mounted onto a post portion of a plant, for example, to a trunk of the tree.

In some embodiments, the methods provided herein include installing an injection tool in the stem, trunk, root or limb of a plant, operatively connecting the injection tool to a fluid delivery system, and activating the fluid delivery system to initiate the flow of fluid from the fluid delivery system through the injection tool and into the plant. In some embodiments, two or more injection tools are installed into one or more of the stem, trunk, roots, limbs or the like of a plant to minimize trauma to the plant (e.g., by minimizing the size of a unitary hole in the plant or spacing the tools apart along the plant). In some such embodiments, the two or more injection tools are operatively connected to the same fluid delivery system. In some such embodiments the two or more injection tools are operatively connected to independent fluid delivery system.

In some variations, the fluid delivery system comprises a spring-loaded fluid delivery system. In some variations of the foregoing, the spring-loaded fluid delivery system is configured to operate at a pressure between 1.5-3 bar. In some variations, the fluid delivery system comprises a fluid delivery system comprising a pressurized container (e.g., a pressurized canister).

In some exemplary embodiments, the spring-loaded fluid delivery system may have a base holding one or multiple springs within one or multiple corresponding syringes. The design of the spring-loaded fluid delivery system may vary based on the pressure, volume, time or other appropriate parameters to deliver the liquid formulation. For example, in some variations, multiple springs (such as a dual spring) may be employed in the fluid delivery system to allow for injection of a higher volume of the liquid formulation. In some variations, a single spring with a larger syringe may be used, but may affect pressure range employed to inject the liquid formulation.

In some variations, the delivery unit is designed as a pneumatically or hydraulically operated dosing pump configured to administer a fluid formulation (e.g., a fluid including one or more of a liquid, gas, gel, vapor, aerosol or the like). Alternatively, the delivery unit is designed as a pneumatic or hydraulic delivery pump configured to provide one or more pressures. In some examples, the pressures provided are proximate to but greater than ambient pressure to provide gradual low pressure delivery of the formulation to a plant. In another example, the delivery unit provides the liquid formulation in a passive manner, for instance by way of hydrostatic pressure or capillary action. The delivery device is, in one example, designed as a two-chamber assembly, wherein two chambers are arranged in a container, of which one chamber contains a pressure medium and the other contains an active ingredient formulation which can be expelled from the two-chamber assembly through a valve by the pressure medium.

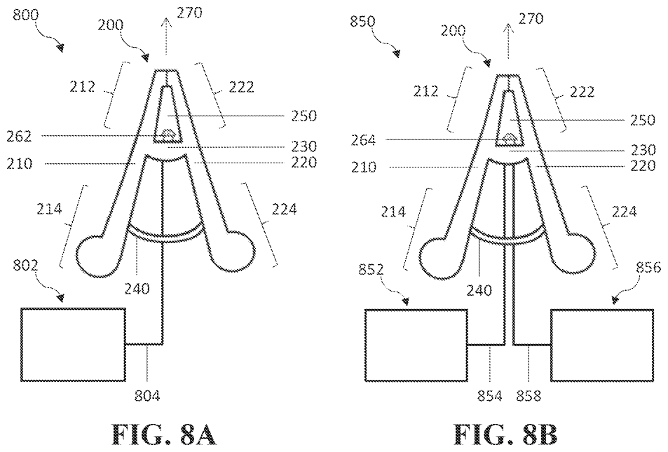

FIG. 8A provides exemplary plant injection system 800 comprising chassis 200 housing single-port injection tool 262. Injection system 800 also comprises fluid delivery system 802, operatively connected to injection tool 262 through delivery interface 804.

FIG. 8B provides exemplary plant injection system 850 comprising chassis 200 housing multiport injection tool 264. Injection system 850 also comprises fluid delivery system 852, operatively connected to injection tool 264 through delivery interface 854. Injection system 850 further comprises fluid receiving system 856, operatively connected to or in fluid connection with injection tool 264 through fluid receiving interface 858.

### Uses of the Injection Systems

In some embodiments, this disclosure provides methods for enhancing or maintaining plant health using the injection systems described herein. In some embodiments, this disclosure provides methods for treating diseased plants and/or methods for controlling bacteria, fungi, viruses and/or other pathogens which cause disease in plants. In further such embodiments, this disclosure provides methods for treating plants whose xylem has been invaded by disease-causing bacteria, fungi, viruses, and/or other pathogens, for controlling the bacteria, fungi, virus and/or other pathogens causing the disease, and for preventing diseases by preventing sufficient colonization of the plant by the disease causing pathogens such as bacteria, fungi, and viruses.

In some embodiments, the method comprises delivering a formulation comprising one or more nutrients into a plant. In some embodiments, the method comprises precision delivery of a formulation into the plant. In some variations, precisely delivering the liquid formulation comprises inserting the injection tool such that the distribution reservoir is positioned in and no further than the active vasculature of the plant.

In some variations, the liquid formulation is delivered into and no further than the active vasculature of the plant when the injection tool is inserted into the post portion of the plant. In some variations, the liquid formulation is delivered into and no further than the active vasculature of the plant when the injection tool is inserted into the stem or trunk of the plant. In some variation, the liquid formulation is delivered into and no further than the xylem, or the phloem or both of the plant when the injection tool is inserted into the post portion of the plant. In one variation, the liquid formulation is delivered into and no further than the xylem, or the phloem or both of the plant when the injection tool is inserted into the stem or trunk of the plant.

In some embodiments, the methods deliver at least 50%, at least 60%, at least 70%, at least 80%, at least 90%, at least 95%, at least 96%, at least 97%, at least 98% or at least 99% of the liquid formulation into to the active vasculature of the plant. In some variation, the methods deliver at least 50%, at least 60%, at least 70%, at least 80%, at least 90%, at least 95%, at least 96%, at least 97%, at least 98% or at least 99% of the liquid formulation into the xylem and/or phloem of the plant.

In some embodiments, the method comprises injecting liquid formulation into the vasculature through one or more sites on post portion of the plant. In some embodiments, the method comprises injecting liquid formulation into the vasculature through one or more sites on the trunk of the tree. In embodiments where the formulation is injected through multiple injection sites, a plurality of the injection systems described herein may be used. In some embodiments where the formulation is injected through multiple injection sites, the system comprises multiple injection tools operatively connected to a single fluid delivery system.

The injection tools, injection systems and methods described herein generally provide one or more commercial advantages over the tools, systems and methods currently known in the art. Advantages include one or more of a faster return to the production yields pre-infection, fast response (e.g., curing), lower volumes of formulation needed, less loss of formulation to the environment, less damage to the tree, response in old trees including trees older than 100 years, response in trees with significant disease symptoms (e.g., with 50% or less remaining canopy foliage and faster administration to the trees).

The injection system according to the disclosure is suitable for being applied to various different plants. Thereby, the shape and dimensions of the injection tools involved advantageously are adapted to the intended application. In some variations, the injection tool can be designed for being applied to comparably small or smaller plants. For example, injection tools intended for comparably small plants optionally have a total length of between approximately 3 mm and 20 mm, between approximately 4 mm and 15 mm, or less than 10 mm.

In a further other aspect, described herein is a process of modulating the phenotype of a plant or a multitude of plants, said process including the steps of (i) installing a plant injection system according to the disclosure provided herein in the plant or multitude of plants, and (ii) applying a liquid formulation of an active ingredient to modulate the phenotype of the plant.

In some embodiments, the active ingredient is selected from the group consisting of (i) pesticides and (ii) growth regulators. In some embodiments, the active ingredient is a biological compound or composition approved for food and feed application.

### Liquid Formulations

Any suitable liquid formulations may be used. In some embodiments, the liquid formulation is water soluble. In some variations, the liquid formulation comprises nutrients. In some variations, the liquid formulation comprises micronutrients. In some variations, the liquid formulation is a semi-liquid formulation. In some variations, the liquid formulation is a gel formulation. In some variations, the liquid formulation is delivered as a semi-liquid or a gel formulation.

Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples of typical formulations include water-soluble liquids (SL), emulsifiable concentrates (EC), emulsions in water (EW), suspension concentrates (SC, SE, FS, OD), water-dispersible granules (WG) and fluids (which include one or more of a liquid, gas, gel, vapor, aerosol or the like). These and other possible types of formulation are described, for example, by Crop Life International and in Pesticide Specifications, Manual on development and use of FAO and WHO specifications for pesticides, FAO Plant Production and Protection Papers, prepared by the FAO/WHO Joint Meeting on Pesticide Specifications, 2004, ISBN: 9251048576, “Catalogue of pesticide formulation types and international coding system”, Technical Monograph No. 2, 6th Ed. May 2008, CropLife International.

Examples for suitable auxiliaries are solvents, liquid carriers, surfactants, dispersants, emulsifiers, wetters, adjuvants, solubilizers, penetration enhancers, protective colloids, humectants, repellents, attractants, feeding stimulants, compatibilizers, bactericides, anti-freezing agents, antifoaming agents, colorants, stabilizers or nutrients, UV protectants, tackifiers and/or binders.

Active Ingredients

In some embodiments, when applying active ingredients, the application can be continuous over a longer period or intervals. In some variations, the application could also be coupled with a disease monitoring system and be triggered “on demand.” In some variations, the formulations can include between 0.5% and 90% by weight of active compound, based on the weight of the formulation.

Numerous active ingredients can be used in the injection systems compatible with the injection systems described herein. The active ingredients specified herein by their “common name” are known and described, for example, in The Pesticide Manual (18^{th} edition, Ed. Dr. J A Tumer (2018), which includes, among other agents, herbicides, fungicides, insecticides, acaricides, nematocides, plant growth regulators, repellents, synergists) or can be searched in the internet (e.g., alanwood.net/pesticides).

In some embodiments, the active ingredient comprises a biological active ingredient. In some embodiments, the active ingredient comprises phage, peptides, polypeptides, proteins, nucleic acids, or any combination thereof. In some embodiments, the active ingredient comprises RNA, DNA, or a combination thereof. In some embodiments, the active ingredient comprises small nuclear RNA (snRNA), micro RNA (miRNA), small interfering RNA (siRNA), messenger RNA (mRNA), or a combination thereof. In some embodiments, the active ingredient comprises a double-stranded RNA such as siRNA. In some embodiments, the active ingredient comprises a non-coding RNA such as snRNA, miRNA, or siRNA, or any combination thereof.

Further, the active ingredient can be selected from the following groups of compounds and compositions:
1. Fungicides
1.1 Respiration Inhibitors
1.1.1 Inhibitors of complex III at Qo site, for example, azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyrao-xystrobin, trifloxystrobin, pyribencarb, triclopyricarb/chlorodincarb, famoxadone, and/or fenamidone;
1.1.2 Inhibitors of complex III at Qi site: cyazofamid and/or amisulbrom;
1.1.3 Inhibitors of complex II: flutolanil, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam and/or thifluzamide:
1.1.4 Other respiration inhibitors (e.g., complex I, uncouplers): diflumetorim;
1.1.5 Nitrophenyl derivates: binapacryl, dinobuton, dinocap, fluazinam; ferimzone; organometal compounds: fentin-acetate, fentin chloride and/or fentin hydroxide; ametoctradin; and/or silthiofam;
1.2 Sterol Biosynthesis Inhibitors (SBI Fungicides)
1.2.1. C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and/or uniconazole;
1.2.2 Imidazoles: imazalil, pefurazoate, prochloraz, triflumizol; pyrimidines, pyridines and piperazines: fenarimol, nuarimol, pyrifenox, triforine; Delta14-reductase inhibitors: aldimorph, dodemorph, dodemorph-acetate, fenpropimorph, tridemorph, fenpropidin, piperalin, spiroxamine; Inhibitors of 3-keto reductase: fenhexamid:
1.3 Nucleic Acid Synthesis Inhibitors:
1.3.1 Phenylamides or acyl amino acid fungicides: benalaxyl, benalaxyl-M, kiral-axyl, metalaxyl, ofurace, oxadixyl; others: hymexazole, octhilinone, oxolinic acid, bupirimate and/or, 5-fluorocytosine:
1.4 Inhibitors of Cell Division and Cytoskeleton
1.4.1 Tubulin inhibitors: benzimidazoles, thiophanates: benomyl, carbendazim, fuberidazole, thiabendazole, thiophanate-methyl; triazolopyrimidines:
1.4.2 Cell division inhibitors: diethofencarb, ethaboxam, pencycuron, fluopicolide, zoxamide, metrafenone and/or, pyriofenone;
1.5 Inhibitors of Amino Acid and Protein Synthesis
1.5.1 Methionine synthesis inhibitors (anilino-pyrimidines): cyprodinil, mepanipyrim, pyrimethanil; protein synthesis inhibitors: blasticidin-S, kasugamycin, kasugamycin hydrochloride-hydrate, mildiomycin, streptomycin, oxytetracyclin, polyoxine, validamycin A:
1.6. Signal Transduction Inhibitors
1.6.1 MAP/histidine kinase inhibitors: fluoroimid, iprodione, procymidone, vinclozolin, fenpiclonil, fludioxonil, G protein inhibitors, quinoxyfen:
1.7 Lipid and Membrane Synthesis Inhibitors
1.7.1 Phospholipid biosynthesis inhibitors: edifenphos, iprobenfos, pyrazophos, isoprothiolane; lipid peroxidation: dicloran, quintozene, teenazene, tolclofos-methyl, biphenyl, chloroneb, etridiazole; phospholipid biosynthesis and cell wall deposition: dimethomorph, flumorph, mandipropamid, pyrimorph, benthiavalicarb, iprovalicarb, valifenalate;
1.7.2 Compounds affecting cell membrane permeability and fatty acids: propamocarb, propamocarb-hydrochlorid, fatty acid amide
1.8 Inhibitors with Multi Site Action
1.8.1 Inorganic active substances: Bordeaux mixture, copper acetate, copper hydroxide, copper oxychloride, basic copper sulfate, sulfur; thio- and dithiocarbamates: ferbam, mancozeb, maneb, metam, metiram, propineb, thiram, zineb, ziram; organochlorine compounds (e.g., phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, and others: guanidine, dodine, dodine free base, guazatine, guazatine-acetate, iminoctadine, iminoctadine-triacetate, iminoctadinetris(albesilate), dithianon:
1.9 Cell Wall Synthesis Inhibitors
1.9.1 Inhibitors of glucan synthesis: validamycin, polyoxin B; melanin synthesis inhibitors: pyroquilon, tricyclazole, carpropamid, dicyclomet and/or fenoxanil;
1.10 Plant Defence Inducers
1.10.1 Acibenzolar-S-methyl, probenazole, isotianil, tiadinil, prohexadione-calcium; phosphonates: fosetyl, fosetyl-aluminum, phosphorous acid and its salts;
1.11 Unclassified Mode of Action/Classification Unknown
1.11.1 Bronopol, chinomethionat, cyflufenamid, cymoxanil, dazomet, debacarb, diclomezine, difenzoquat, difenzoquat-methylsulfate, diphenylamin, fenpyrazamine, flumetover, fluoxastrobin, flusulfamide, flutianil, fluxapyroxad, mefenoxam, methasulfocarb, nitrapyrin, nitrothal-isopropyl, oxine-copper, picarbutrazox, prothiconazole, proquinazid, pydiflumetofen (Adepidyn), pyraclostrobin, tebufloquin, tecloftalam, triazoxide, and/or trifloxystrobin;
1.12 Antifungal biological Control Agents: Ampelomyces quisqualis (e.g., AQ 10® from Intrachem Bio GmbH & Co. KG, Germany), Aspergillus flavus (e.g., AFLAGUARD® from Syngenta, CH), Aureobasidium pullulans (e.g., BOTECTOR® from bio-ferm GmbH, Germany), Bacillus pumilus (e.g., NRRL Accession No. B-30087 in SONATA® and BALLAD® Plus from AgraQuest Inc., USA), Bacillus subtilis (e.g., isolate NRRL-Nr. B-21661 in RHAPSODY®, SERENADE® MAX and SERENADE®ASO from AgraQuest Inc., USA), Bacillus subtilis var. amyloliquefaciens FZB24 (e.g., TAEGRO® from Novozyme Biologicals, Inc., USA), Candida oleophila 1-82 (e.g., ASPIRE® from Ecogen Inc., USA), Candida saitoana (e.g., BIOCURE® (in mixture with lysozyme) and BIOCOAT® from Micro Flo Company, USA (BASF SE) and Arysta), Chitosan (e.g., ARMOUR-ZEN from BotriZen Ltd., NZ), Clonostachys rosea f. catenulata, also named Gliocladium catenulatum (e.g., isolate J1446: PRESTOP® from Verdera, Finland), Coniothyrium minitans (e.g., CONTANS® from Prophyta, Germany), Cryphonectria parasitica (e.g., Endothia parasitica from CNICM, France). Cryptococcus albidus (e.g., YIELD PLUS® from Anchor Bio-Technologies, South Africa), Fusarium oxysporum (e.g., BIOFOX® from S.I.A.P.A., Italy, FUSACLEAN® from Natural Plant Protection, France). Metschnikowia fructicola (e.g., SHEMER® from Agrogreen, Israel), Microdochium dimerum (e.g., ANTIBOT® from Agrauxine, France), Phlebiopsis gigantea (e.g., ROTSOP® from Verdera, Finland), Pseudozyma flocculosa (e.g., SPORODEX® from Plant Products Co. Ltd., Canada), Pythium oligandrum DV74 (e.g., POLYVERSUM® from Remeslo SSRO, Biopreparaty, Czech Rep.), Reynoutria sachlinensis (e.g., REGALIA® from Marrone Bio-Innovations, USA), Talaromyces flavus V117b (e.g., PROTUS® from Prophyta, Germany), Trichoderma asperellum SKT-1 (e.g., ECO-HOPE® from Kumiai Chemical Industry Co., Ltd., Japan), T. atroviride LC52 (e.g., SENTINEL® from Agrimm Technologies Ltd, NZ), T. harzianum T-22 (e.g., PLANTSHIELD® der Firma BioWorks Inc., USA), T. harzianum TH35 (e.g., ROOT PRO® from Mycontrol Ltd., Israel), T. harzianum T-39 (e.g., TRICHODEX® and TRICHODERMA 2000® from Mycontrol Ltd., Israel and Makhteshim Ltd., Israel). T. harzianum and T. viride (e.g., TRICHOPEL from Agrimm Technologies Ltd, NZ). T. harzianum ICC012 and T. viride ICC080 (e.g., REMEDIER® WP from Isagro Ricerca, Italy), T. polysporum and/or T. harziamum (e.g., BINAB® from BINAB Bio-Innovation AB, Sweden), T. stromaticum (e.g., TRICOVAB® from C.E.P.L.A.C., Brazil), T. virens GL-21 (e.g., SOILGARD® from Certis LLC, USA), T. viride (e.g., TRIECO® from Ecosense Labs. (India) Pvt. Ltd., Indien, BIO-CURE® F from T. Stanes & Co. Ltd., Indien), T. viride TV1 (e.g., T. viride TV1 from Agribiotec srl, Italy), Ulocladium oudemansi HRU3 (e.g., BOTRY-ZEN® from Botry-Zen Ltd, NZ), Beauveria bassiana PPRI 5339 (commercially available from Becker Underwood as product “BroadBand”), Metarhizium anisopliae FI-1045 (commercially available from Becker Underwood as product “BioCane”), Metarhizium anisopliae var. acridum FI-985 (commercially available from Becker Underwood as product “GreenGuard”), and/or Metarhizium anisopliae var. acridum IMI 330189 (commercially available from Becker Underwood as product “Green Muscle”).

In some embodiments, active ingredients can also include peptides, proteins, or secondary metabolites. The term “peptides, proteins, or secondary metabolites” refers to any compound, substance or by-product of a fermentation of a microorganism that has pesticidal activity. The definition includes any compound, substance or by-product of a fermentation of a microorganism that has pesticidal, including, fungicidal, insecticidal, or nematocidal activity. Examples of such proteins or secondary metabolites are Harpin (isolated from Erwinia amylovora, product known as e.g., Harp-N-Tek™, Messenger®, Employ™, ProActr™); and/or terpene constituents and mixture of terpenes, i.e. a-terpinene, p-cymene and limonene (product known as e.g., Requiem® from Bayer CropScience LP, US).

In some embodiments, useful proteins may also include antibodies against fungal target proteins, or other proteins with antifungal activity such as defensins and/or proteinase inhibitor. Defensins may include, for example, NaD1, PhD1A, PhD2, Tomdef2, RsAFP2, RsAFP1, RsAFP3 and RsAFP4 from radish, DmAMP1 from dahlia, MsDef1, MtDef2, CtAMP1, PsD1, HsAFP1, VaD1, VrD2, ZmESR6, AhAMP1 and AhAMP4 from Aesculus hippocatamum, AfIAFP from alfalfa, NaD2, AX1, AX2, BSD1, EGAD1, HvAMP1, JI-2, PgD1, SD2, SoD2, WT1, p139 and p1230 from pea. Proteinase inhibitors may include proteinase inhibitor from the following classes: serine-, cysteine-, aspartic- and metallo-proteinase inhibitors and carboxypeptidases such as StPin1A (U.S. Pat. No. 7,462,695) or Bovine Trypsin Inhibitor I-P.
2. Insecticidal Compound
2.1 Acetylcholine esterase inhibitors from the class of carbamates: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and/or, triazamate;
2.2 Acetylcholine esterase inhibitors from the class of organophosphates: acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl)salicylate, isoxathion, malathion, mecarbam, methamidophos, methidathion, mevinphos, monocrotophos, nalad, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and/or vamidothion;
2.3 GABA-Gated Chloride Channel Antagonists
2.4 Cyclodiene organochlorine compounds: endosulfan; or M-2.B fiproles (phenylpyrazoles): ethiprole, fipronil, flufiprole, pyrafluprole, or pyriprole:
2.5 Sodium channel modulators from the class of pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, betacyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, momfluorothrin, empenthrin, esfenvalerate, etofenprox, fenpropathrin, fenvalerate, flucythrinate, flumethrin, tau-fluvalinate, halfenprox, imiprothrin, meperfluthrin, metofluthrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin, DDT and/or, methoxychlor;
2.6 Nicotinic acteylcholine receptor agonists from the class of neonicotinoids: acteamiprid, chlothianidin, cycloxaprid, dinotefuran, flupyradifurone, imidacloprid, nitenpyram, sulfoxaflor, thiacloprid and/or thiamethoxam;
2.7 Allosteric nicotinic acteylcholine receptor activators from the class of spinosyns: spinosad, spinetoram;
2.8 Chloride channel activators from the class of mectins: abamectin, emamectin benzoate, ivermectin, lepimectin and/or milbemectin;
2.9 Juvenile hormone mimics: hydroprene, kinoprene, methoprene, fenoxycarb and/or pyriproxyfen;
2.10 Non-specific multi-site inhibitors: methyl bromide and other alkyl halides, chloropicrin, sulfuryl fluoride, borax and/or tartar emetic;
2.11 Selective homopteran feeding blockers: pymetrozine, flonicamid and/or pyrifluquinazon;
2.12 Mite growth inhibitors: clofentezine, hexythiazox, diflovidazin and/or etoxazole;
2.13 Inhibitors of mitochondrial ATP synthase: diafenthiuron, azocyclotin, cyhexatin, fenbutatin oxide, propargite and/or tetradifon:
2.14 Uncouplers of oxidative phosphorylation: chlorfenapyr, DNOC and/or sulfluramid; M-13 nicotinic acetylcholine receptor channel blockers: bensultap, cartap hydrochloride, thiocyclam and/or thiosultap sodium;
2.15 Inhibitors of the chitin biosynthesis type 0 (benzoylurea class): bistrifluron, chlorfluazuron, diflubenzuron, flucycloxuron, flufenoxuron, hexaflumuron, lufenuron, novaluron, noviflumuron, teflubenzuron and/or, triflumuron;
2.16 Inhibitors of the chitin biosynthesis type 1: buprofezin;
2.17 Moulting disruptors: cyromazine;
2.18 Ecdyson receptor agonists: methoxyfenozide, tebufenozide, halofenozide, fufenozide and/or chromafenozide;
2.19 Octopamin receptor agonists: amitraz;
2.20 Mitochondrial complex III electron transport inhibitors: hydramethylnon, acequinocyl, flometoquin, fluacrypyrim and/or pyriminostrobin:
2.21 Mitochondrial complex I electron transport inhibitors: fenazaquin, fenpyroximate, pyrimidifen, pyridaben, tebufenpyrad, tolfenpyrad, flufenerim and/or rotenone;
2.22 Voltage-dependent sodium channel blockers: indoxacarb and/or metaflumizone
2.23 Inhibitors of the lipid synthesis, inhibitors of acetyl CoA carboxylase: spirodiclofen, spiromesifen and/or spirotetramat:
2.24 Mitochondrial complex II electron transport inhibitors: cyenopyrafen, cyflumetofen and/or pyflubumide;
2.25 Ryanodine receptor-modulators from the class of diamides: flubendiamide, chloranthraniliprole (rynaxypyr) and/or cyanthraniliprole (cyazypyr),
2.26 Others: afidopyropen, imidacloprid, thiodicarb, clothianidin, and/or abamectin:
2.27 Insecticidal biological control agents: Bacillus firmus (e.g., Bacillus firmus CNCM 1-1582, e.g., WO09126473A1 and WO09124707 A2, commercially available as “Votivo”) and/or δ-endotoxins from Bacillus thuringiensis (Bt).
3. A Plant Growth Regulator:
3.1 Antiauxins: clofibric acid and/or 2,3,5-tri-iodobenzoic acid:
3.2 Auxins: 4-CPA, 2,4-D, 2,4-DB, 2,4-DEP, dichlorprop, fenoprop, IAA (indole-3-acetic acid), IBA, naphthaleneacetamide, α-naphthaleneacetic acid, I-naphthol, naphthoxyacetic acid, potassium naphthenate, sodium naphthenate and/or 2,4,5-T;
3.3 Cytokinins: 2iP, 6-benzylaminopurine (6-BA), 2,6-dimethylpyridine and/or kinetin, zeatin;
3.4 Defoliants: calcium cyanamide, dimethipin, endothal, merphos, metoxuron, pentachlorophenol, thidiazuron, tribufos and/or tributyl phosphorotrithioate;
3.5 Ethylene modulators: aviglycine, 1-methylcyclopropene (1-MCP), prohexadione (prohexadione calcium) and/or trinexapac (trinexapac-ethyl);
3.6 Ethylene releasers: ACC, etacelasil, ethephon, glyoxime; Gibberellins: gibberelline, gibberellic acid:
3.7 Growth inhibitors: abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat (mepiquat chloride, mepiquat pentaborate), piproctanyl, prohydrojasmon, propham and/or 2,3,5-tri-iodobenzoic acid;
3.8 Morphactins: chlorfluren, chlorflurenol, dichlorflurenol and/or flurenol;
3.9 Growth retardants: chlormequat (chlormequat chloride), daminozide, flurprimidol, mefluidide, paclobutrazol, tetcyclacis, uniconazole and/or metconazole;
3.10 Growth stimulators: brassinolide, forchlorfenuron, and/or hymexazol;
3.11 Unclassified plant growth regulators/classification unknown: amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, inabenfide, kinetin, karetazan, lead arsenate, methasulfocarb, polyamines, pydanon, salicylic acids, sintofen and/or, triapenthenol.

In one embodiment, the fungicidal compound is selected from the group of Oxathiapiprolin, Dimoxystrobin, Pyraclostrobin, Azoxystrobin, Trifloxystrobin, Picoxystrobin, Cyazofamid, Boscalid. Fluoxapyroxad, Fluopyram, Bixafen, Isopyrazam, Benzovindiflupyr, Penthiopyrad, Ametoctradin, Difenoconazole, Metconazole, Prothioconazole, Tebuconazole, Propiconazole, Cyproconazole, Penconazole, Myclobutanil, Tetraconazole, Hexaconazole, Metrafenone, Zoxamid, Pyrimethanil, Cyprodinil, Metalaxyl, Fludioxonil, Dimethomorph, Mandipropamid, Tricyclazole, Copper, Metiram, Chlorothalonil, Dithianon, Fluazinam, Folpet, Fosetyl-Al, Captan, Cymoxanil, Mancozeb, Kresoxim-methyl, Oryzastrobin, Epoxiconazole, Fluquinconazole, Triticonazole, Fenpropimorph, or Iprodione.

In one embodiment, the plant growth regulator is selected from the group of 6-benzylaminopurine (═N-6-benzyladenine), chlormequat (chlormequat chloride), choline chloride, cyclanilide, dikegulac, diflufenzopyr, dimethipin, ethephon, flumetralin, fluthiacet, forchlorfenuron, gibberellic acid, inabenfide, maleic hydrazide, mepiquat (mepiquat chloride), 1-methylcyclopropene (1-MCP), paclobutrazol, prohexadione (prohexadione calcium), prohydrojasmon, thidiazuron, triapenthenol, Tributyl phosphorotrithioate, trinexapac-ethyl, or uniconazole.

In another embodiment, the active ingredient is a biological control agent such as a bio-pesticide. In some embodiments, compared to conventional synthetic chemical pesticides, bio-pesticides are non-toxic, safe to use, and can have high specificity. In some variations, these can be used as a preventative (or curative) tool to manage diseases, nematodes and insects and other pests. In some embodiments, bio-pesticides allow for the reduction in the use of traditional chemical-based pesticides without affecting yields. The use of biological pesticides is compatible with the use for food and feed production and many of the biological agents are approved for consumption. This allows an all year use in food production systems like wine, banana, cocoa, coffee, and fruit plantations etc. where pest control is a major and increasing challenge. In one embodiment, the tools, systems and methods of the disclosure are employed in organic farming.

In one embodiment, the active ingredients are those which provide a systemic effect.

Non-Systemic Active Ingredients

In some embodiments, the active ingredients are non-systemic. Non-systemic active ingredients may be recalcitrant to uptake by the seedling or plant vasculature, movement in the seedling or plant vasculature, or uptake by the seed when applied externally. Numerous non-systemic active ingredients can be used in the injection systems compatible with the injection system systems described herein.

Penetrants

In some embodiments, penetrants which facilitate and/or enhance the uptake and distribution of the active ingredient in the target plant can be used in the injection systems or injection tools compatible with the injection systems described herein. Suitable penetrants in the present context include all those substances which are typically used in order to enhance the penetration of active agrochemical compounds into plants. Examples include alcohol alkoxylates, such as coconut fatty ethoxylate, isotridecyl ethoxylate, fatty acid esters, such as rapeseed or soybean oil methyl esters, fatty amine alkoxylates, such as tallowamine ethoxylate, or ammonium and/or phosphonium salts, such as ammonium sulphate or diammonium hydrogen phosphate.

1. A chassis configured to house an injection tool, wherein the chassis comprises:
a large arm, comprising a first gripping end, a first actuating end, and a first connecting portion between the first gripping end and the first actuating end;
a small arm, comprising a second gripping end, a second actuating end, and a second connecting portion between the second gripping end and the second actuating end; and
a biasing element coupling the first actuating end and the second actuating end, and configured to push the first gripping end and the second gripping end toward each other,
wherein the first connecting portion is larger than the second connecting portion,
wherein the first connecting portion is connected to the second connecting portion to form a hinge,
wherein the first gripping end, the second gripping end, and the first connecting portion form a jaw profile,
wherein the injection tool is mounted on the first connecting portion and within the jaw profile, and configured to insert into a plant part in the same direction as the longitudinal axis of the chassis, and to distribute a liquid formulation to the plant part,
wherein, when the chassis is in a relaxed mode, the first actuating end and the second actuating end are maximally separated from each other,
wherein, when the chassis is in a strained mode, the first actuating end and the second actuating end are closer to each other than in the relaxed mode, and the first gripping end and the second gripping end are further away from each other than in the relaxed mode.

2. The chassis of claim 1, wherein the large arm and the small arm comprises a rigid material.

3. The chassis of claim 2, wherein the rigid material comprises metal.

4. The chassis of claim 1, wherein the biasing element is a spring.

5. The chassis of claim 1, wherein the biasing element comprises metal, rubber, or silicone.

6. A plant injection system, comprising:
an injection tool; and
a chassis according to claim 1.

7. The system of claim 6, wherein the plant injection system is configured to operate in a pre-insertion configuration and an installed configuration,
wherein, in the pre-insertion configuration, the plant part is placed between the first gripping arm and the second gripping arm, but the injection tool is not inserted into the plant part,
wherein, in the installed configuration, the plant part is placed between the first gripping arm and the second gripping arm, and the injection tool is at least partly inserted into the plant part.

8. A chassis configured to house an injection tool, wherein the chassis comprises:
a first arm, comprising a first gripping end and a first actuating end;
a second arm, comprising a second gripping end and a second actuating end;
a connecting portion connecting the first arm and the second arm between the gripping and actuating ends; and
a biasing element coupling the first actuating end and the second actuating end, and configured to push the first gripping end and the second gripping end toward each other,
wherein the first gripping end, the second gripping end, and the connecting portion form a jaw profile,
wherein the injection tool is mounted on the connecting portion and within the jaw profile, and configured to insert into a plant part in the same direction as the longitudinal axis of the chassis, and to distribute a liquid formulation to the plant part,
wherein, when the chassis is in a relaxed mode, the first actuating end and the second actuating end are maximally separated from each other,
wherein, when the chassis is in a strained mode, the first actuating end and the second actuating end are closer to each other than in the relaxed mode, and the first gripping end and the second gripping end are further away from each other than in the relaxed mode.

9. The chassis of claim 8, wherein the first arm, the second arm, and the connecting portion comprises a rigid material.

10. The chassis of claim 9, wherein the rigid material comprises metal.

11. The chassis of claim 8, wherein the biasing element is a spring.

12. The chassis of claim 8, wherein the biasing element comprises metal, rubber, or silicone.

13. A plant injection system, comprising:
an injection tool; and
a chassis according to claim 8.

14. The system of claim 13, wherein the plant injection system is configured to operate in a pre-insertion configuration and an installed configuration,
wherein, in the pre-insertion configuration, the plant part is placed between the first gripping arm and the second gripping arm, but the injection tool is not inserted into the plant part,
wherein, in the installed configuration, the plant part is placed between the first gripping arm and the second gripping arm, and the injection tool is at least partly inserted into the plant part.

15. A chassis configured to house an injection tool, wherein the chassis comprises:
a first arm, comprising a first pivoting end and a first actuating end;
a second arm, comprising a second pivoting end and a second actuating end;
a clamp, comprising a first side, a second side, and a base that form a U-shape having an interior surface and an exterior surface, wherein the first and second pivoting ends are mounted on the exterior surface of the clamp on the base; and
a biasing element connected to the exterior surface of the clamp on the first side and the second side, and configured to push the first side and the second side toward each other,
wherein the injection tool is mounted onto the interior surface of the clamp on the base, configured to insert into a plant part in the same direction as the longitudinal axis of the chassis, and to distribute a liquid formulation to the plant part,
wherein, when the chassis is in a relaxed mode, the first actuating end and the second actuating end are maximally separated from each other,
wherein, when the chassis is in a strained mode, the first actuating end and the second actuating end are closer to each other than in the relaxed mode, and the first pivoting end and the second pivoting end causes the clamp to expand.

16. The chassis claim 15, wherein the biasing element comprises metal or rubber.

17. The chassis of claim 15, wherein the first side, the second side, and the base comprises plastic or silicone.

18. A plant injection system, comprising:
an injection tool; and
a chassis according to claim 15.

19. The system of claim 18, wherein the plant injection system is configured to operate in a pre-insertion configuration and an installed configuration,
wherein, in the pre-insertion configuration, the plant part is placed between the first side and the second side, but the injection tool is not inserted into the plant part,
wherein, in the installed configuration, the plant part is placed between the first side and the second side, and the injection tool is at least partly inserted into the plant part.

20. A chassis configured to house an injection tool, wherein the chassis comprises:
a clamp comprising a first side, a second side, and a base that form a U-shape having an interior surface and an exterior surface, wherein the first side has one or more holes, and the second side has one or more corresponding holes; and
a fixing element configured to insert into one hole on the first side and a corresponding hole on the second side;
wherein the injection tool is mounted onto the interior surface of the clamp on the base, and configured to insert into a plant part in the same direction as the longitudinal axis of the chassis, and to distribute a liquid formulation to the plant part.

21. A chassis configured to house an injection tool, wherein the chassis comprises:
a base having an inner surface and an outer surface;
a button mounted on the outer surface of the base and configured to push the injection tool into a plant part; and
one or more fixing elements configured to mount the base onto a plant part,
wherein the injection tool is mounted on the inner surface of the base, and configured to penetrate the plant part and distribute a liquid formulation to the plant part.

22. The chassis of claim 21, wherein the inner surface is bent to approximate the curvature of the plant part.

23. A plant injection system, comprising:
an injection tool; and
a chassis according to claim 20.

24. The system of claim 6, further comprising:
a fluid delivery system, operatively connected to the injection tool.

25. The system of claim 24, wherein the injection tool is a multiport injection tool, and the system further comprising:
a fluid receiving system, wherein the fluid receiving system is in fluid communication with the multiport injection tool.

26. The system of claim 6, wherein the longitudinal length of the exposed part of the injection tool when the injection tool is housed in the chassis is less than 2.5 mm.

27. A method of using the chassis of claim 1, wherein the method comprises:
squeezing the first actuating end and the second actuating end toward each other;
placing the plant part between the first gripping arm and the second gripping arm;
inserting at least a part of the injection tool into the plant part by pushing the chassis toward the plant part in the same direction as the longitudinal axis of the chassis; and
releasing the first actuating end and the second actuating end.

28. A method of using the chassis of claim 8, wherein the method comprises:
squeezing the first actuating end and the second actuating end toward each other;
placing the plant part between the first gripping arm and the second gripping arm;
inserting at least a part of the injection tool into the plant part by pushing the chassis towards the plant part in the same direction as the longitudinal axis of the chassis; and
releasing the first actuating end and the second actuating end.

29. A method of using the chassis of claim 15, wherein the method comprises:
squeezing the first actuating end and the second actuating end toward each other;
placing the plant part between the first side and the second side;
inserting at least a part of the injection tool into the plant part by pushing the chassis toward the plant part in the same direction as the longitudinal axis of the chassis; and
releasing the first actuating end and the second actuating end.

30. A method of using the chassis of claim 20, wherein the method comprises:
placing the plant part between the first side and the second side;
inserting at least a part of the injection tool into the plant part by pushing the chassis towards the plant part in the same direction as the longitudinal axis of the chassis; and
inserting the fixing element into one hole on the first side and a corresponding hole on the second side to surround the plant part with the clamp.

31. A method of using the chassis of claim 21, wherein the method comprises:
bringing the inner surface of the base in contact with the plant part;
mounting the base on the plant part using the one or more fixing elements; and
inserting at least a part of the injection tool into the plant part by pushing the button.

32. The method of claim 27, further comprising injecting the liquid formulation into the plant part.
